(19) United States
(12) Patent Application Publication
(10) Pub. No.: US 2007/0113967 A1
(43) Pub. Date: May 24, 2007

(54) Radiation absorbing compositions, methods and articles made by applying such compositions

(76) Inventors: Daniel M. Connor, Inman, SC (US); Keith A. Keller, Spartanburg, SC (US); John G. Lever, Spartanburg, SC (US)

Correspondence Address: John E. Vick, Jr.;Milliken & Company, Legal Department, M-495, P.O. Box 1926, Spartanburg, SC, 29304, US

(21) Appl. No.: 11/285,840

(22) Filed: Nov. 23, 2005

(51) Int. Cl. B32B 37/00

(52) U.S. Cl. 156/272.2; 428/500

(57) ABSTRACT

Infrared (IR) radiation absorbing compounds of metal or metalloids with ligands are beneficial for many applications. Schiff base biquinone (SBB) ligands surrounding a metal or metalloid center may be used for laser welding applications, as one example, wherein effective infrared radiation absorption and heat resistance are required. These compounds may be known as Schiff base biquinone metal complexes (SBBC's). The compositions and methods of this invention provide examples of many different NIR absorbing compounds that exhibit high NIR absorbing strength, good thermal stability, and relatively low visible color. These NIR absorbing compounds may have application in many different applications, including laser welding of thermoplastics, and in IR reflecting fabrics.

### BACKGROUND OF THE INVENTION

Infrared (IR) radiation absorbing compounds are beneficial for many applications. They are useful in optical recording media, thermal writing display, laser printing, laser filters, IR photography, medical applications, plastic reheat, laser welding, laser marking and for protective goggles for welding and for protection from lasers in military applications. Several classes of IR absorbing compounds are known including carbon black, inorganic pigments, metals, organic dyes, and organic pigments.

Many classes of organic IR dyes are known including squaric acid dyes, croconic acid dyes, imminium dyes, cyanines, anthraquinones, quaterylenes, perylenes, porphryins, triphenylmethanes, polymethines, quinine dyes, azos, and others. Organometallic IR absorbers are also known including metal phthalocyanine, metal naphthocyanine, and metal dithiolenes. A thorough review of IR absorbing compounds has been published (Chem. Rev. 1992, 92, 1197-1226).

Infrared radiation is commonly defined as “light” with wavelength greater than 700 nm and less than 1 mm. Near IR (NIR) light is commonly defined as radiation with a wavelength between 700 nm and 14,000 nm. The majority of common NIR absorbing dyes and pigments have maximum IR absorbance between 700 nm and 3000 nm. Most common NIR dyes absorb between about 700 nm and 1500 nm. Compounds such as carbon black, which are black-body absorbers, absorb over a very broad wavelength range.

It is highly desirable for NIR absorbing compounds to have strong NIR absorbance yet have minimal visible light absorbance (i.e., absorbance between 400 nm and 700 nm). These compounds are advantageous for use in non-colored and lightly colored transparent applications where strong NIR absorption without strong color is desired. Some advantageous NIR compounds are mostly transparent to visible light in liquid or plastic compositions.

To be highly useful in many applications, a NIR absorber must have several properties in addition to absorption at the desired wavelength. The absorption efficiency must be sufficiently strong (as characterized by the molar absorptivity constant). The compound(s) should be sufficiently soluble or compatible in the medium in which it is used. Further, the compound should be sufficiently thermally and oxidatively stable to facilitate incorporation and use in the desired application without excessive degradation during the desired lifetime of the absorber.

Transmission laser welding is a well known method for joining thermoplastic articles. In one embodiment of this technique an IR laser beam is passed through an IR transparent part and impinges on a second part containing IR absorbing species. These IR absorbing species can be contained in the bulk of the polymer through melt mixing or applied to the interface between the two parts as a coating. The IR absorbing species absorbs sufficient energy from the laser to melt the surrounding plastic. The molten plastic from the two parts flows together and cools to form a strong joint or weld. It is necessary for the IR absorbing species to be thermally stable enough to survive for a brief period of time in the molten polymer. A higher level of thermal stability is needed for incorporation of the IR absorbing compound into the molten polymer during the fabrication of the article. It is particularly advantageous for the IR absorbing compound to impart minimal color in or on the resulting part, although this is not always necessary. Thus, there is a need in this industry for compounds that will afford the correct absorption characteristics, and also exhibit a high level of thermal stability, while imparting minimal color upon welded parts or seams. Few NIR dyes have the correct combination of properties for incorporation into thermoplastic media or to be used for laser welding via a coating. Of the few that are known, cyanine, imminium/diimonium, quaterylenes, metal dithiolenes, and squaryliums are most common. Many of these compounds are difficult and expensive to make.

There exists therefore a strong need for new and improved IR absorbing compounds. There is a need in the industry for NIR absorbing compounds that are easy to manufacture, with sufficient thermal stability for incorporation into plastic. Such compounds may be used for many different applications, including for example for laser welding through a coating. It would be desirable to incorporate compounds that provide a relatively low visible absorption and impart minimal color to articles in which they are incorporated.

### BRIEF DESCRIPTION OF THE DRAWING

FIG. 1 shows IR reflectance spectra for compositions of Example 55.

### DETAILED DESCRIPTION OF THE INVENTION

In the practice of the invention, it is possible to employ compounds as IR absorbers and as additives for plastics in a manner which has not been recognized to date. Below is a compound of general Formula 1, in which R₁-R₄ may be the same or different and consist of alkyl, branched alkyl, cycloalkyl, aryl, substituted aryl, heteroaryl, alkoxy, halogen, dialkylamino, polyoxyalkylene, carboxyl, acyl, or hydrogen. Some R₁-R₄ groups that may be particularly useful include: methyl, ethyl, isopropyl, tert-amyl, isobutyl, and tert-butyl. 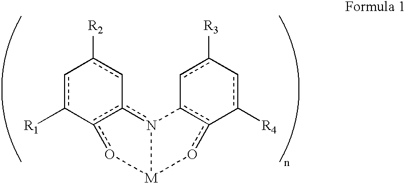
These compounds are characterized by Schiff base biquinones (SBB) surrounding a metal center. The structure in Formula 1 is intended to encompass any of numerous oxidation states, electronic states, resonance forms, or tautomers. In the chemical literature these SBB ligands are known as stable dianionic semiquinonato radicals, monoanionic dienones with no unpaired electrons, or other canonical forms (see, for example, Cador, O. Inorganic Chemistry 2003, 42, 6432-6440; Chaudhuri, P. Inorganic Chemistry 1999, 38, 2781-2790). These compounds can be termed Schiff base biquinone metal complexes (SBBCs). A number of metal centers have been disclosed for SBBC complexes and these complexes are known to exist in a number of oxidation states. However, such compositions comprising SBBCs in thermoplastics or thermoset polymers are not known, nor have they been disclosed for use in laser welding, laser filters, as compositions in such IR absorbing coatings, or for the dyeing of textile materials, as examples.

In some instances, a di-alkyl substituted catechol is a useful group to employ in the synthesis of compounds of the invention. Also, since R₁-R₄ may be hydrogen, there is a good selection of monosubstituted catechols that may be employed in the practice of the invention. In the Formula 1 above, n is from about 1 to about 4.

Catechols based on 3,5-di-alkyl substituted catechol (1,2-dihydroxybenzene) may be employed, including for example: 3-methyl-5-isopropyl, 3,5-dimethyl, 3-methyl-5-ethyl, 3-methyl-5-t-butyl, 3-t-butyl-5-methyl, 3,5-disopropyl, 5-methyl-3-(1,1,3,3-tetramethylbutyl), 3-t-butyl-5-t-octyl, 5-t-butyl-3-(1,1-dimethyl-hexyl), 3,5-didodecyl, 3-methyl-5-propyl, 3,5-bis-(2,2-dimethyl-propyl), 5-(1,1-dimethyl-hexyl)-3-methyl, 3-methyl-5-(1,1,3,3-tetramethylbutyl), 3,5-di-t-amyl, 3-(1,1-dimethyl-hexyl)-5-methyl, 3-t-butyl-5-t-octyl, 5-t-butyl-3-t-octyl, 3,5-bis-(1,1-dimethyl-hexyl), 3,5-Bis-(1,1,3,3-tetramethyl-butyl), 3-Methyl-5-(1,1,3,3,5,5-hexamethyl-hexyl), 5-methyl-3-(1,1,3,3,5,5-hexamethyl-hexyl), 5-methyl-3-pentadecyl, 3,5-di-n-propyl, 3-isopropyl-5-(1,1,3,3-tetramethyl-butyl), 5-t-butyl-3-methyl, 5-methyl-3-t-butyl, 3-t-butyl-5-isopropyl, 3-isopropyl-5-t-butyl, 3,5-dioctadecyl, 3-t-butyl-5-ethyl, 3-t-butyl-5-isopropyl, 3,5-di-n-dibutyl, 3,5-di(1,1,2,2-tetramethylpropyl), and 3,5-di-2-ethylhexyl.

Monoalkyl substituted catechol compounds can be employed as well, including for example: 3-methyl, 5-methyl, 3-ethyl, 5-ethyl, 3-isopropyl, 5-isopropyl, 3-n-propyl, 5-n-propyl, 3-butyl, 5-butyl, 3-sec-butyl, 5-sec-butyl, 3-t-butyl, 5-t-butyl, 3-(1-methylbutyl), 5-(1-methylbutyl), 3-amyl, 5-amyl, 3-(1,1,3,3-tetramethylbutyl), 5-(1,1,3,3-tetramethylbutyl), 3-(2,2-dimethylpropyl), 5-(2,2-dimethylpropyl), 3-(2-ethylhexyl), 5-(2-ethylhexyl), 3-(1,1-dimethylhexyl), 5-(1,1-dimethylhexyl), 3-t-amyl, 5-t-amyl, 3-(1,1,3,3,5,5-hexamethyl-hexyl), 3-(1,1,2,2-tetramethylpropyl), 5-(1,1,2,2-tetramethylpropyl), 3-hexyl, 5-hexyl, 3-heptyl, 5-heptyl, 3-octyl, and 5-octyl

This invention provides examples of many different NIR absorbing compounds that exhibit high NIR absorbing strength, good thermal stability, and low visible color. These NIR absorbers may have application in optical recording media, thermal writing, dying of textile materials, electronic display, laser printing, laser filters, IR photography, medical applications, plastic reheat, laser welding, laser marking and for protective goggles for welding and for protection from lasers in military applications.

The invention may provide a wide range of compositions of matter. First, a thermoplastic or thermoset composition containing the compound of Formula 1 above may be employed. The metal-like species (i.e. “M” in Formula 1 or 2) may be a metal, metalloid, a semi-conductor, a lanthanide series element, or a actinide series element in any oxidation state, valence, or electronic state. R₁-R₄ may be the same or different and are comprised of: alkyl, branched alkyl, cycloalkyl, aryl, substituted aryl, heteroaryl, alkoxy, halogen, dialkylamino, polyoxyalkylene, carboxyl, acyl, or hydrogen. Species that may be quite useful for R₁-R₄ include, among others: methyl, ethyl, isopropyl, isobutyl, tert-amyl, and tert-butyl.

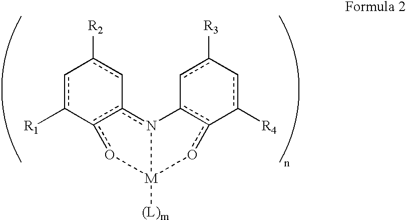

A thermoplastic or thermoset comprising the compound shown in Formula 2 is disclosed as well, in which there may be a metal, metalloid, or semi-conductor, lanthanide series element, or actinide series element provided as “M”, and in which R₁-R₄ may be the same or different and consist of alkyl, branched alkyl, cycloalkyl, aryl, substituted aryl, heteroaryl, alkoxy, halogen, dialkylamino, polyoxyalkylene, carboxyl, acyl, or hydrogen. Species that may be quite useful include: methyl, ethyl, isopropyl, isobutyl, tert-amyl, and tert-butyl. In the Formula 2 above, n is from about 1 to about 4, and m is also from about 1 to about 4.

In the compound of Formula 2, additional ligands (L)ₘ may also be present around the metal or metalloid center in compounds as in Formula 2, such as (but not limited to) the following: pyridine, bipyridine, terpyridine, chloride or other halogens, perchlorate, sulfate, phosphate, organophosphate, phosphines, cyclopentadienyl, acetate, malonate, alkanoate, benzoates, acetylacetonate, alkoxide, oxide, Schiff bases, amines, imines, thiols, diamines, thiolenes, indoanilines, azos, formazyls, phthalocyanines, phenyl, substituted phenyl, and merocyanines, carbonyl, cyano, oxo, carboxyl, aqua, hydroxo, sulfato, sulfito, nitrito, nitro, nitrosyl, isothiocyanato, thiosulfato, ethylene diamine, oxalato, ethylene diamine tetraacetic acid, cabonato, amido, imido, nitrido, ammino, peroxo, phosphato, phosphito, phosphido, borato, sulfido, porphyrin, monoximes, crown ethers, cryptates, chromato, chromito, hydrido, cyclypentyldieno, aryls, and thiacyls. The “m” may be from about 1 to about 4.

Compositions useful for applications described herein may include as well coloring agents, ultraviolet absorbers, light stabilizers, acid scavengers, bluing agents, color-correction agents, anti-microbial agents, slip agents, plasticizers, impact modifiers, anti-oxidants, fillers, clarifiers, nucleating agents, or mixtures thereof, as liquids or as pellets for further introduction within desired molten thermoplastic or thermoset formulations (or precursor formulations). Methods of making such compositions, particularly thermoplastics, comprising such compounds of are also contemplated within this invention.

The “M” in Formulas 1 or 2 may be essentially any metal, or other species as herein defined. Representative examples are shown herein at Table 1, however, the invention is not limited to only those metals set forth in Table 1. Metals that may have application include, without limitation, the following (chemical symbols): K, Cs, La, Bi, Sb, Zr, In, and Mo. These metals may have particular application when applied with catechols based on 3,5-di-alkyl substituted catechol (1,2-dihydroxybenzene). The application of the invention is not limited to only those metals disclosed herein.

The term “thermoplastic” is intended to encompass any synthetic polymeric material that exhibits a modification in physical state from solid to liquid upon exposure to sufficiently high temperatures. Most notable of the thermoplastic types of materials are polyolefins (i.e., polypropylene, polyethylene, and the like), polyester (i.e., polyethylene terephthalate, polybutylene terephthalate, polytrimethylene terephthalate, and the like), polyamides (i.e., nylon-1,1, nylon-1,2, nylon-6 or nylon-6,6), polystyrenes, polycarbonates, polyvinyl halides (i.e., polyvinyl chloride and polyvinyl difluoride), polylactic acid, acrylate polymers, as examples). Thermoplastics that are readily employed in the practice of the invention include polypropylene, polystyrene, polymethylmethacrylate, polycarbonate, nylon, polyethylene, and polyester.

Thermoplastic articles that may benefit from application of the compounds of the invention may include bottles, storage containers, sheets, films, fibers, plaques, hoses, tubes, syringes, medical devices, and electronics components. Included are polyester, polystyrene, polycarbonate, polyacrylates, and other like resinous materials in sheet form which are present within windows for strength and resiliency functions. In such an instance, the inventive NIR absorbing compounds provide or contribute to excellent IR absorption to such thermoplastic articles for decorative, aesthetic or protective purposes. The possible uses for such NIR absorbers for such items as thermoplastics are many. Possible end-uses include use of such compounds within solvent systems, printing inks, within and with textiles (either on or within textiles, fibers, or fabrics) within display devices such as liquid crystal displays, in or on electronic recording media.

The inventive NIR absorbing compounds may be added in any amount to such thermoplastics as is needed to provide beneficial results. The amount may be between about 0.00001 ppm to about 25,000 ppm per total amount of resin; in some instances from about 0.001 and about 15,000 ppm; in other applications may be between about 0.1 to about 5,000 ppm; and in still other applications from about 100 to about 2,500 ppm. The more NIR absorber present, the stronger IR absorption therein.

The term “thermoset” or “thermosets” refers to a polymeric solid which upon exposure to sufficient heat or in the presence of a sufficient amount of catalyst, configures itself into a pre-determined shape. Foams, sheets, articles, coverings, and the like are all possible, and are within the scope of the invention. Examples of such thermosets include polyurethane, epoxies, phenolic resins, unsaturated polyester systems, thermoset polycarbonates and the like.

The inventive NIR absorbing compounds may be added in any amount to such thermosets up to their saturation limits. The amount may be between about 0.00001 ppm to about 25,000 ppm per total amount of resin; in other aspects, may be from about 0.001 to about 15,000 ppm; in other applications may be between about 0.1 to about 5,000 ppm. The more NIR absorber present in a composition, the stronger the IR absorption therein. When mixed with other colorants within the target thermoset, the same amounts may be used within the saturation limit, i.e. dependent upon the amount of any extra colorants therein.

Thermoplastic or thermoset IR absorbers (and other additives) are added to such compositions during the injection molding (or other type of molding, such as blow molding) and without limitation, by mixing the absorber with resin pellets and melting the entire coated pellets, or through a masterbatch melting step while the resin and absorber are pre-mixed and incorporated together in pellet form. Such plastics include for example polyolefins, polyesters, polyamides, polyurethanes, polycarbonates, and other well known resins. Generally, such plastics, including the IR absorber, colorant, UV absorber, and other potential additives, are formed by way of any number of extrusion techniques.

In one application of the invention, at least a first and second polymeric article is provided. The compounds as described herein in Formula 1 and/or 2 may be applied upon, or more likely within, the polymeric article. The polymeric article may be a thermoplastic, or polyolefin, or other compound. The articles are placed closely together. Then, radiation such as laser radiation is applied. The compound absorbs the radiation, and forms heat which melts a portion of the polymeric articles. Then, the radiation is removed, thereby bonding the first polymeric article to the second polymeric article.

In yet another embodiment of the invention, a textile or a fabric may receive a deposit of such compounds as in Formula 1 or 2. A fabric or textile of reduced IR reflectance can be made. Such a fabric may be useful as electronic camouflage, for avoiding infrared detection of items positioned within or behind the fabric. This could have military applications.

Another embodiment of this invention includes compositions comprising the inventive IR absorbers of Formula 1 or 2 in solutions or dispersions suitable for application to solid substrates such as thermoplastics, thermosets, paper, or textile articles, including fabrics. Such compositions may include solvents, dispersing agents, coagulants, thickening agents, colorants, chelating agents, and the like. Such solutions or dispersions may be solvent or aqueous based and may be useful for applying the inventive IR absorbers to plastic parts for laser welding and to fabrics for improved IR absorption. Such solutions designed for use in applications such as optical recording media, thermal writing displays, laser printing, laser filters, IR photography, medical applications, plastic reheat, laser welding, laser marking and for protective goggles for welding and for protection from lasers in military applications are also envisioned within the scope of the invention.

In one embodiment, a hydrotalcite compound such as DHT-4A® from Mitsui and Company may be employed, as further set forth in examples below. This compound may assist in the radiation welding applications, as well as in other applications.

The novel described metal centered IR absorbers offer significant advantages in color and cost. Absorbers are suitable for polymer reheat with low color, laser imaging, laser light protection, laser welding plastics with low color, and for many other applications. The compounds used in the prior art are expensive and often have high color and low thermal stability.

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

### EXAMPLES

General Procedure for the Preparation of SBBC Compounds (Direct Formation)

3,5-di-tert butyl-catechol (4.5 equivalents) was combined with a metal salt (1 equivalent), and 28% aqueous ammonium hydroxide (about 30 equivalents) in an ethanol solvent. The mixture was stirred overnight at room temperature with an air sparge. The material was filtered, washed with water, washed with ethanol, and dried. Recrystallization from chloroform/ethanol was sometimes needed. In some cases it was necessary to hot-filter the recrystallization solutions to remove insoluble materials.

General Procedure for the Preparation of SBBC Compounds (Transmetallation)

The transmetallation route is exemplified by using the Zn SBBC to synthesize the Sb SBBC. Zn SBBC (1.0 g), SbCl₃ (0.25 g), and methylene chloride (30 mL) were stirred at room temperature overnight with an air sparge. Water (25 mL) was added and the organic layer was collected using a separatory funnel. Ethanol was added to precipitate the product. Yield was 0.25 g.

Procedure for the Preparation of Zn(SBB)(Pyr)₂

### Example 22

Zinc dichloride (1.52 g) and 5.38 g of 3,5-di-t-butylcatechol were dissolved in 1.9 mL of 28% NH₄OH and 40 mL of pyridine. The reaction mixture was stirred at room temperature overnight under air. The solid precipitate was filtered off and washed with hexanes, and dried in a vacuum oven at 50° C. H¹-NMR and powder x-ray diffraction were consistent with 2 pyridines per SBB ligand and metal center.

TABLE 1
Various Metals and Lambda Max Values for IR

| | | | Lambda Max in |
|---|---|---|---|
| Example # | Metal Used | Metal Source | IR (nm) |
| 1 | Aluminum | AlCl₃•6H₂O | 765, 946 |
| 2 | Antimony | SbCl₃ | 1066 |
| 3 | Bismuth | Bi(NO₃)₃•5H₂O | 780 |
| 4 | Calcium | CaCl₂ | 732, 785 |
| 5 | Cerium | Ce(NO₃)₃•6H₂O | 855, 865 |
| 6 | Cesium | CsCl | 801 |
| 7 | Copper | CuCl₂ | 766, 842 |
| 8 | Gallium | Ga(NO₃)₃•H₂O | 783 |
| 9 | Indium | InCl₃•4H₂O | 724 |
| 10 | Lanthanum | LaCl₃•6H₂O | 765, 813 |
| 11 | Magnesium | MgCl₂ | 726, 800 |
| 12 | Molybdenum | MoCl₅ | 847 |
| 13 | Nickel | Ni(NO3)2•8H₂O | 766 |
| 14 | Potassium | KCl | 801 |
| 15 | Tin | SnCl₄•5H₂O | 1010 |
| 16 | Titanium | TiCl₄ | 1020 |
| 17 | Tungsten | WCl₄ | 827 |
| 18 | Yttrium | YCl₃•6H₂O | 749, 819 |
| 19 | Ytterbium | YbCl₃•6H₂O | 746, 818 |
| 20 | Zinc | ZnCl₂ | 735, 800 |
| 21 | Zirconium | ZrOCl₂•8H₂O | 836 |

### Plastic Compositions

For many of the compounds in this class, the absorption in the NIR can be broad so the reported absorption maxima in the examples are only reported as approximate values. Lambda Max values reported herein are typical of those measured on UV-Vis Spectrophotometric apparatus.

Polypropylene (PP)

The following formulation was used to compound the inventive IR absorbers into polypropylene for extrusion.

| | | |
|---|---|---|
| Polypropylene homopolymer - (12 MFI) | 995.2 | g |
| Millad 3988 ® (Milliken Chemical) | 2.5 | g |
| Irganox 1010 ® (Ciba Specialty Chemical) | 1.0 | g |
| Irgafos 168 ® (Ciba Specialty Chemical) | 1.0 | g |
| DHT-4A (Mitsui & Co.) | 0.2 | g |
| Inventive IR absorber | 0.1-1.0 | g |

The additives and the polymer pellets were mixed thoroughly. The material was compounded on a 16 mm Prism co-rotating twin screw extruder with a length/diameter ratio of 25:1. The temperature set-points for the heaters for running all PP examples was 210-220° C.

Injection Molding PP Plaques

The PP resin which had been compounded with the inventive IR absorbing additives was injection molded on an Arburg 221-75-350 40-ton injection molding machine with a barrel temperature of 230° C. The pellets were gravity fed into the feed throat of the machine. In the feed section, melting was accomplished through the utilization of a heated (heat transferred from the barrel of the machine) screw extruder which rotated. The rotation of the screw provided thorough mixing of the additive and molten resin together producing a uniform plastic melt which was injected into a mold in order to form the thermoplastic article, for instance a 2 inch by 3 inch plaque with a uniform thickness of 50 mils. Plaques were used for gathering spectroscopic data in the table.

TABLE 2
SBBC-Polypropylene Compositions (Injection Molded Plaques)

| | | Loading | |
|---|---|---|---|
| Example # | Metal | (ppm) | Lambda Max in IR |
| 23 | Zr | 1000 | 722*, 792, 812, 1025 |
| 24 | Fe | 100 | 842*, 892 |
| 25 | Mg | 1000 | 720*, 787 |
| 26 | Al | 500 | 715, 774*, 898, 955 |
| 27 | Mn | 500 | 809, 897*, 1075 |
| 28 | La | 100 | 758*, 805, 1014 |
| 29 | Ce | 1000 | 790 |
| 30 | Ni | 100 | 764*, 841 |
| 31 | In | 500 | 744*, 885, 1014 |
| 32 | Sn | 500 | 925, 998* |

*Indicates strongest absorption

Compression Molding PP Articles

Clarified random copolymer polypropylene (30 MFI) clarified with Millad® 3988) was cryo-ground into a powder. DHT-4A (2000 ppm), the inventive IR absorbers (500 ppm), and the PP fluff were thoroughly mixed with a mortar and pestle. The samples were compression molded into 50 mil disks on a Carver Lab Press operating at 400° F. and 15000 psi.

TABLE 3
SBBC-PP Compositions (Compression Molded Plaques)

| Example # | Metal | Loading | Lambda Max in IR (nm) |
|---|---|---|---|
| 33 | Sn | 500 | 988 |

Compression Molding PMMA Articles

Polymethymethacrylate (Cyro Acrylite® M-30) was cryo-ground into a powder. DHT-4A (2000 ppm), the inventive IR absorbers (500 ppm), and the PMMA fluff were thoroughly mixed with a mortar and pestle. The samples were compression molded into 50 mil plaques on Carver Lab Press operating at 320-370° F. and 15000 psi.

TABLE 4
SBBC-PMMA Compositions (Compression Molded Plaques)

| Example # | Metal | Loading | Lambda Max in IR (nm) |
|---|---|---|---|
| 34 | Sn | 500 | 1032 |
| 35 | La | 500 | 898 |
| 36 | Mg | 500 | 999 |

Compression Molding PS Articles

Polystyrene (Atofina PS500) was cryo-ground into a powder. DHT-4A (800 ppm), the inventive IR absorbers (500 ppm), and the PS fluff were thoroughly mixed with a mortar and pestle. The samples were compression molded into 50 mil thick plaques on a Carver Lab Press operating at 350-400° F. and 15000 psi.

TABLE 5
SBBC-PS Compositons (Compression Molded Plaques)

| Example # | Metal | Loading | Lambda Max in IR (nm) |
|---|---|---|---|
| 37 | Sn | 500 | 1032 |
| 38 | La | 500 | 797 |
| 39 | Y | 500 | 761 |
| 40 | Yb | 500 | 754 |
| 41 | Zn*(SBB)(Py)₂ | 500 | 736, 799 |

Compression Molding PC Articles

Polycarbonate (Bayer Makrolon® 2407), DHT-4A (800 ppm), and the inventive IR absorbers (500 ppm) were thoroughly mixed. The samples were compression molded into 50 mil plaques on a Carver Lab Press operating at 550° F. and 15000 psi.

TABLE 6
SBBC-PC Compositions (Compression Molded Plaques)

| Example # | Metal | Loading | Lambda Max in IR (nm) |
|---|---|---|---|
| 42 | Sn | 500 | 1020 |

Compression Molding Polyester Articles

Amorphous PET (Eastman Eastar® 6763), DHT-4A (800 ppm) and the inventive IR absorbers (500 ppm) were thoroughly mixed. The samples were compression molded into 30 mil plaques on a Carver Lab Press operating at 440-500° F. and 15000 psi.

TABLE 7
SBBC-Amorphous PET Compositions (Compression Molded Plaques)

| Example # | Metal | Loading | Lambda Max in IR (nm) |
|---|---|---|---|
| 43 | Sn | 500 | 1020 |
| 44 | La | 500 | 897 |

Injection Molding PET Plaques

PET pellets (M&G 8006) were dried to a water level of less than 50 ppm and mixed with the inventive IR absorbers on a Hobart mixer. The samples were injection molded on an Arburg 220M-35-90 40-ton injection molding machine with a barrel temperature of 540-550° F. The pellets were gravity fed into the feed throat of the machine. In the feed section, melting was accomplished by utilization of a heated (heat transferred from the barrel of the machine) screw extruder which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils.

TABLE 8
SBBC-PET Compositions (Injection Molded Plaques)

| Example # | Metal | Loading | Lambda Max in IR (nm) |
|---|---|---|---|
| 45 | Sn | 500 | 1030 |

Injection Molding PS Plaques

Polystyrene (Atofina PS500) [Previously compounded with the inventive IR absorbers (500 ppm) and DHT-4A (800 ppm) on a Prism twin screw extruder] were injection molded on an Arburg Allrounder® injection molding machine with a barrel temperature of 215° C. The pellets were gravity fed into the feed throat of the machine. In the feed section, melting was accomplished by utilization of a heated (heat transferred from the barrel of the machine) screw extruder which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils.

TABLE 9
SBBC-PS Compositions (Injection Molded Plaques)

| Example # | Metal | Loading | Lambda Max in IR (nm) |
|---|---|---|---|
| 46 | Sn | 500 | 1032 |
| 47 | La | 500 | 797 |
| 48 | Y | 500 | 761, 843 |
| 49 | Yb | 500 | 754, 831 |

Injection Molding PC Plaques

Polycarbonate (Bayer Makrolon® 2407), DHT-4A (2000 ppm) was dried and mixed with the inventive IR absorbers (500 ppm) and DHT-4A (2000 ppm) on a Hobart mixer. The mixtures were injection molded on an Arburg Allrounder® injection molding machine with a barrel temperature of 277° C. The pellets were gravity fed into the feed throat of the machine. In the feed section, melting was accomplished by utilization of a heated (heat transferred from the barrel of the machine) screw extruder which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils.

TABLE 10
SBBC-PC Compositions (Injection Molded Plaques)

| Example # | Metal | Loading | Lambda Max in IR (nm) |
|---|---|---|---|
| 50 | Sn | 500 | 1020 |

Injection Molding PMMA Plaques

Polymethylmethacrylate (Cyro Acrylite® M-30) was dried and mixed with the inventive IR absorbers (500 ppm) and DHT-4A (2000 ppm) on a Hobart mixer. The mixtures were injection molded on an Arburg Arburg Allrounder® injection molding machine with a barrel temperature of 210° C. The pellets were gravity fed into the feed throat of the machine. In the feed section, melting was accomplished by utilization of a heated (heat transferred from the barrel of the machine) screw extruder which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils.

TABLE 11
SBBC-PMMA Compositions (Injection Molded Plaques)

| Example # | Metal | Loading | Lambda Max in IR (nm) |
|---|---|---|---|
| 51 | Sn | 500 | 1032 |

Laser Welding

### Examples 52-54

Plaques from example 51 were successfully transmission laser welded to control PMMA plaques (50 mil). Excellent bonding was observed.

Plaques from example 46 were successfully transmission laser welded to control PS plaques (50 mil). Excellent bonding was observed.

Plaques from example 32 were successfully transmission laser welded to control PP plaques (50 mil). Excellent bonding was observed.

A method of joining two polymeric articles is contemplated in which a first polymeric article and a second polymeric article may be fused or melted together in a weld. At least one of the polymeric articles contains a compound as set forth above in Formula 1 or 2, in which IR radiation absorbing compounds assist in the absorption of IR radiation which cause melting which cause the formation of a bond or weld. The articles are placed together, and then radiation is applied to the polymeric articles. The compound within or upon one of the articles absorbs the radiation, which heats and melts a portion of said first or said second polymeric articles. Then, when the radiation is removed there is bonding of the first polymeric article to the second polymeric article.

### Example 55

Dying of Fabric

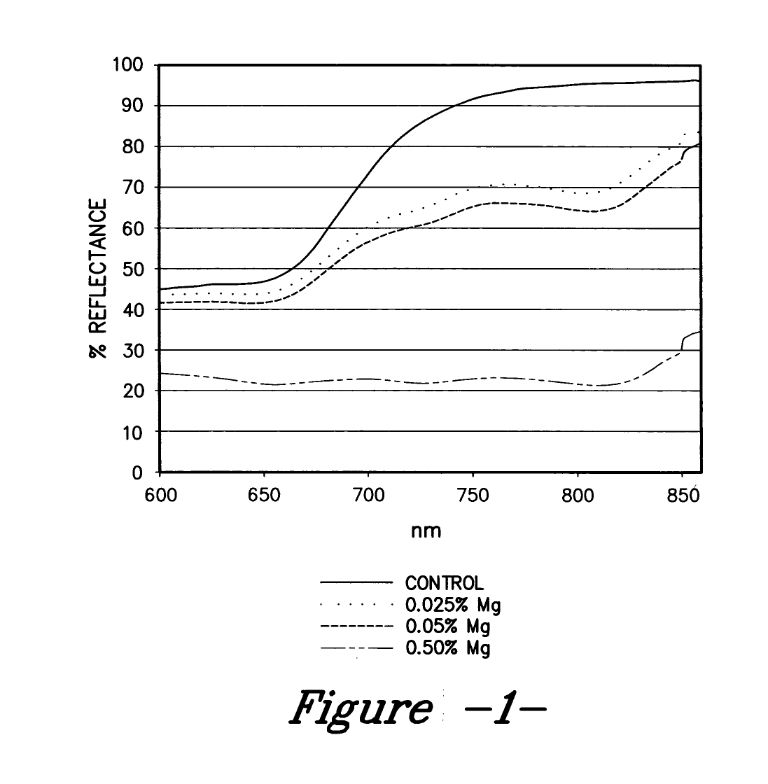

Dichloromethane solutions of Mg SBBC were made (from 0.025-0.5 wt %) and nylon fabric was dip dyed, soaking in solvent for 1 min. The IR reflectance spectra are shown in FIG. 1, indicating a substantial decrease in the IR reflectance. Such a fabric could have applications in essentially any field in which it is important for the fabric, when it received IR radiation, to provide a decrease in the amount of reflected IR. Such a fabric could have many applications, including the use as a camouflage barrier, for example, which resists detection by IR radiation detection methods. The fabric could be a knit, or essentially any woven or non-woven fabric. The fabric could be made of synthetic materials, such as polyester, or natural materials, such as cotton, or a poly-cotton blend, as a few representative examples.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A thermoplastic composition comprising a radiation absorbing compound, said compound comprising: 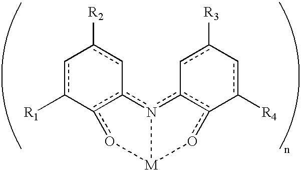
wherein:
(a) R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, carboxyl, acyl, and hydrogen;
(b) n is from about 1 to about 4; and
(c) wherein said M comprises one or more selected from the group consisting of: metals, metalloids, semi-conductors, lanthanide series elements, and actinide series elements.

2. The composition of claim 1 wherein said thermoplastic composition comprises a thermoplastic selected from the group consisting of: polyester, polycarbonate, polystyrene, polyacrylate, polypropylene, polyethylene, and block copolymers.

3. The composition of claim 1 wherein at least one of said R₁-R₄ comprises an alkyl, said alkyl being selected from one or more of the following: methyl, ethyl, isopropyl, isobutyl, tert-amyl and tert-butyl.

4. The composition of claim 3 wherein said thermoplastic composition additionally comprises a hydrotalcite compound.

5. The composition of claim 2 wherein said thermoplastic composition comprises a polyacrylate.

6. A method of joining or bonding two polymeric articles, said method comprising:
(a) providing a first polymeric article,
(b) providing a second polymeric article,
(c) providing within or upon said first or said second polymeric article a compound: 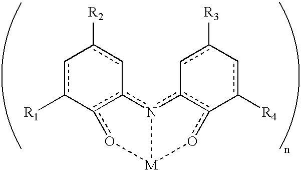
wherein:
R₁, R₂, R₃ and R₄ are independently selected from the group consisting of: alkyl, branched alkyl, cycloalkyl, aryl, substituted aryl, heteroaryl, alkoxy, halogen, carboxyl, acyl, dialkylamino, polyoxyalkylene, and hydrogen, and n is from about 1 to about 4, and wherein said M comprises one or more selected from the group consisting of: metals, metalloids, semi-conductors, lanthanide series elements, and actinide series elements;
(d) placing said first and second polymeric articles closely together;
(e) applying radiation to said polymeric articles, wherein said compound absorbs said radiation and forms heat and melts a portion of said first or said second polymeric articles; and
(f) thereby bonding said first polymeric article to said second polymeric article.

7. A fabric having reduced IR reflectance, said fabric comprising a compound: 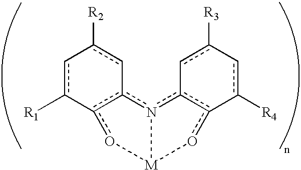
wherein:
(a) R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, carboxyl, acyl, and hydrogen;
(b) n is from about 1 to about 4; and
(c) wherein said M comprises one or more selected from the group consisting of: metals, metalloids, semi-conductors, lanthanide series elements, and actinide series elements.

8. A thermoplastic composition comprising a radiation absorbing compound, said radiation absorbing compound comprising: 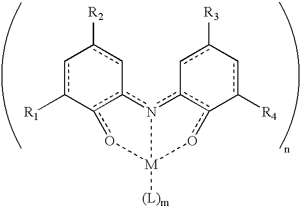
wherein:
(a) R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, carboxyl, acyl, and hydrogen; and
(b) n is from about 1 to about 4;
(c) wherein said M comprises one or more selected from the group consisting of: metals, metalloids, semi-conductors, lanthanide series elements, and actinide series elements; and
(d) said (L)ₘ comprises a ligand, and m is from about 1 to about 4.

9. The thermoplastic composition of claim 8 wherein said ligand (L)ₘ is selected from the group consisting of: pyridine, bipyridine, terpyridine, chloride or other halogens, perchlorate, sulfate, phosphate, organophosphate, phosphines, cyclopentadienyl, acetate, malonate, alkanoate, benzoates, acetylacetonate, alkoxide, oxide, Schiff bases, amines, imines, thiols, diamines, thiolenes, indoanilines, azos, formazyls, phthalocyanines, phenyl, substituted phenyl, and merocyanines, carbonyl, cyano, oxo, carboxyl, aqua, hydroxo, sulfato, sulfito, nitrito, nitro, nitrosyl, isothiocyanato, thiosulfato, ethylene diamine, oxalato, ethylene diamine tetraacetic acid, cabonato, amido, imido, nitrido, ammino, peroxo, phosphato, phosphito, phosphido, borato, sulfido, porphyrin, monoximes, crown ethers, cryptates, chromato, chromito, hydrido, cyclypentyldieno, aryls, and thiacyls.

10. A thermoplastic article comprising the composition of claim 8.

11. The thermoplastic composition of claim 8 wherein said thermoplastic comprises at least one selected from the group consisting of: polyester, polycarbonate, polystyrene, polyacrylate, and block copolymers.

12. A method of joining at least two thermoplastic polymeric articles, said method comprising:
(a) providing a first polymeric article,
(b) providing a second polymeric article,
(c) providing within or upon said first or said second polymeric article a compound: 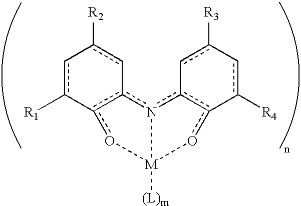
wherein:
R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, acyl, carboxyl, and hydrogen;
n is from about 1 to about 4, and (L)ₘ comprises a ligand; wherein said M comprises one or more selected from the group consisting of: metals, metalloids, semi-conductors, lanthanide series elements, and actinide series elements, with m being between about 1 and about 4;
(d) placing said first and second polymeric articles closely together;
(e) applying radiation to said polymeric articles, wherein said compound absorbs said radiation and generates heat to partially melt said first and/or second polymeric articles; and
(f) removing said radiation,
(g) thereby bonding said first polymeric article to said second polymeric article.

13. The method of claim 12, wherein said ligand (L)ₘ is selected from the group consisting of: pyridine, bipyridine, terpyridine, chloride or other halogens, perchlorate, sulfate, phosphate, organophosphate, phosphines, cyclopentadienyl, acetate, malonate, alkanoate, benzoates, acetylacetonate, alkoxide, oxide, Schiff bases, amines, imines, thiols, diamines, thiolenes, indoanilines, azos, formazyls, phthalocyanines, phenyl, substituted phenyl, and merocyanines, carbonyl, cyano, oxo, carboxyl, aqua, hydroxo, sulfato, sulfito, nitrito, nitro, nitrosyl, isothiocyanato, thiosulfato, ethylene diamine, oxalato, ethylene diamine tetraacetic acid, cabonato, amido, imido, nitrido, ammino, peroxo, phosphato, phosphito, phosphido, borato, sulfido, porphyrin, monoximes, crown ethers, cryptates, chromato, chromito, hydrido, cyclypentyldieno, aryls, and thiacyls.

14. A radiation absorbing compound, said compound comprising: 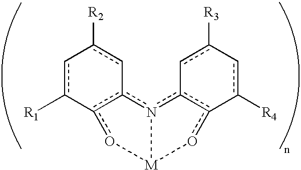
wherein:
(a) R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, carboxyl, acyl, and hydrogen; and
(b) n is from about 1 to about 4; and
(c) wherein the M is selected from one or more of the following: K, Cs, Bi, Sb, Zr, and Mo.

15. The compound of claim 14, wherein at least one of said R₁, R₂, R₃ and R₄ comprises an alkyl group.

16. The composition containing the compound of claim 15, wherein said composition additionally comprises a hydrotalcite.

17. The compound of claim 14, wherein said compound is additionally characterized by a ligand (L)ₘ associated with M.

18. The compound of claim 17 wherein said ligand (L)ₘ is selected from is selected from the group consisting of:
pyridine, bipyridine, terpyridine, chloride or other halogens, perchlorate, sulfate, phosphate, organophosphate, phosphines, cyclopentadienyl, acetate, malonate, alkanoate, benzoates, acetylacetonate, alkoxide, oxide, Schiff bases, amines, imines, thiols, diamines, thiolenes, indoanilines, azos, formazyls, phthalocyanines, phenyl, substituted phenyl, and merocyanines, carbonyl, cyano, oxo, carboxyl, aqua, hydroxo, sulfato, sulfito, nitrito, nitro, nitrosyl, isothiocyanato, thiosulfato, ethylene diamine, oxalato, ethylene diamine tetraacetic acid, cabonato, amido, imido, nitrido, ammino, peroxo, phosphato, phosphito, phosphido, borato, sulfido, porphyrin, monoximes, crown ethers, cryptates, chromato, chromito, hydrido, cyclypentyldieno, aryls, and thiacyls.

19. A welded thermoplastic article comprising the compound of claim 14 in said article.

20. A fabric having reduced IR reflectance, said fabric having within or upon the fabric the compound of claim 14.

21. A method of joining polymeric articles, said method comprising:
(a) providing a first polymeric article,
(b) providing a second polymeric article,
(c) applying a coating upon at least one of said first or second polymeric articles, said coating comprising the compound: 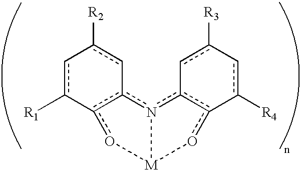
wherein:
R₁, R₂, R₃ and R₄ are independently selected from the group consisting of: alkyl, branched alkyl, cycloalkyl, aryl, substituted aryl, heteroaryl, alkoxy, halogen, dialkylamino, polyoxyalkylene, acyl, carboxyl, and hydrogen;
n is from about 1 to about 4, and (L)ₘ comprises a ligand; and
wherein said M comprises one or more selected from the group consisting of: metals, metalloids, semi-conductors, lanthanide series elements, and actinide series elements.
(d) placing said first and second polymeric articles closely together, with said coating is positioned therebetween;
(e) applying radiation to said coating, wherein said compound absorbs said radiation and generates heat to partially melt said first or second polymeric article;
(f) removing said radiation, and
(g) thereby bonding said first polymeric article to said second polymeric article.

22. A coated polymeric article which has been joined according to the method of claim 21.

23. A polymeric composition comprising a thermoplastic or thermoset polymer and an infrared absorbing compound formed by:
(a) dissolving an ortho-dihydroxy substituted aromatic compound with a source of ammonia in an organic solvent,
(b) adding a metal salt;
(c) facilitating the absorption of oxygen, thereby forming an IR absorbing compound; and
(d) isolating the formed IR absorbing compound.

24. A coating for laser welding of polymers comprising:
(a) a solvent, and
(b) an infrared absorbing compound formed by:
dissolving an ortho-dihydroxy substituted aromatic compound with a source of ammonia in an organic solvent;
adding a metal salt;
permitting the absorption of oxygen; and
isolating the formed IR absorbing compound in a polymeric substrate.
